(19) United States
(12) Patent Application Publication
(10) Pub. No.: US 2018/0253923 A1
(43) Pub. Date: Sep. 6, 2018

(54) CHECKOUT MACHINE

(71) Applicant: TOSHIBA TEC KABUSHIKI KAISHA, Tokyo (JP)

(72) Inventors: Yuya URANAKA, Izunokuni Shizuoka (JP); Tetsuhiko KIMOTSUKI, Kawasaki Kanagawa (JP); Tomotake NIINO, Izunokuni Shizuoka (JP); Shino TAKEUCHI, Izu Shizuoka (JP)

(21) Appl. No.: 15/909,910

(22) Filed: Mar. 1, 2018

(30) Foreign Application Priority Data
Mar. 1, 2017 (JP) 2017-037924

(51) Int. Cl. G07D 1/06; G07G 1/00; G07G 1/06; G07G 1/12

(52) U.S. Cl. CPC G07D 1/06; G07G 1/12; G07G 1/06; G07G 1/0009

(57) ABSTRACT

A checkout machine includes a bill discharge section, a coin discharge section, a communication interface, and a processor configured to acquire attribute information of a group through the communication interface, determine a distribution pattern of change on the basis of the attribute information, and control the bill discharge section and the coin discharge section to dispense change according to the determined distribution pattern.

### CROSS-REFERENCE TO RELATED APPLICATION

This application is based upon and claims the benefit of priority from Japanese Patent Application No. 2017-037924, filed Mar. 1, 2017, the entire contents of which are incorporated herein by reference.

### FIELD

Embodiments described herein relate generally to a settlement apparatus and a method thereof.

### BACKGROUND

Splitting the cost of food and drink by a group in a restaurant is widely carried out. For example, if a price of 1,400 yen is split by three people to a unit of one yen, two people pay 467 yen, and the third person pays 466 yen. In such a case, exact calculation among payers is not carried out.

Also, in such circumstances, it is desired that split payment can be easily carried out.

### DESCRIPTION OF THE DRAWINGS

FIG. 1 is a perspective view illustrating an appearance of a checkout apparatus according to an embodiment;

FIG. 2 is a block diagram illustrating a circuit arrangement of main portions of the checkout apparatus shown in FIG. 1;

FIG. 3 is a diagram schematically illustrating an example of order reception data;

FIG. 4 is a diagram schematically illustrating an example of setting data;

FIG. 5 is a flowchart depicting information processing for settlement by a processor shown in FIG. 2;

FIG. 6 is a flowchart depicting the information processing for settlement by the processor shown in FIG. 2;

FIG. 7 is a diagram illustrating an example of a settlement screen;

FIG. 8 is a diagram illustrating an example of a first confirmation screen;

FIG. 9 is a diagram illustrating an example of a second confirmation screen;

FIG. 10 is a diagram illustrating an example of a third confirmation screen; and

FIG. 11 is a diagram illustrating an example of a receipt.

### DETAILED DESCRIPTION

In accordance with an embodiment, a checkout machine includes a bill discharge section, a coin discharge section, a communication interface, and a processor configured to acquire attribute information of a group through the communication interface, determine a distribution pattern of change on the basis of the attribute information, and control the bill discharge section and the coin discharge section to dispense change according to the determined distribution pattern.

Hereinafter, an example of an embodiment is described with reference to the accompanying drawings. Furthermore, in the present embodiment, a semi-self-service checkout apparatus (hereinafter, briefly referred to as a checkout apparatus) having a function as a settlement apparatus is described.

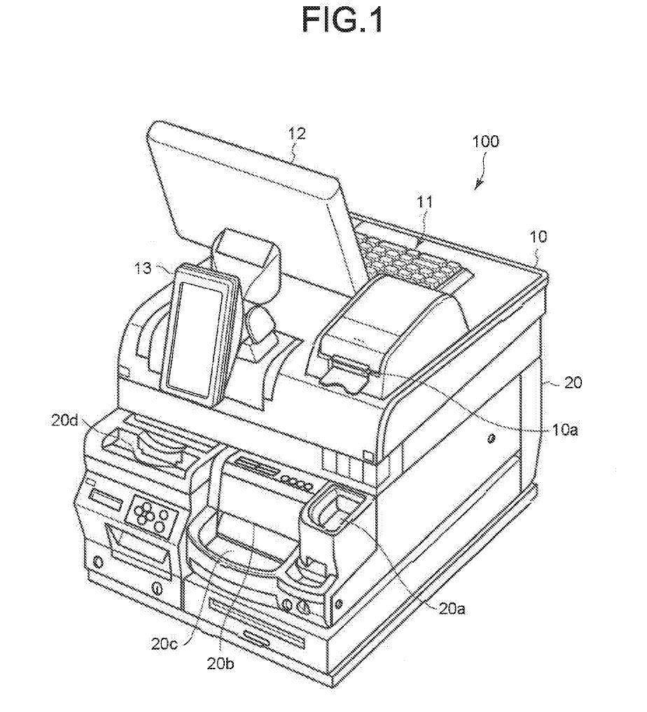

FIG. 1 is a perspective view illustrating an appearance of a checkout apparatus 100 according to the present embodiment.

The checkout apparatus 100 is installed in, for example, a checkout corner of a restaurant, and is used for settling a payment for food and drink. However, the settlement through the checkout apparatus 100 is not limited to the payment for the food and drink, and can also be used for a settlement relating to any other transaction. The checkout apparatus 100 is used in a state in which a store clerk is positioned at a right back side in FIG. 1 and a customer is positioned at a left front side, respectively. Thus, in the following, the right back side in FIG. 1 is referred to as a store clerk side, and the left front side is referred to as a customer side.

A main unit 10 includes a keyboard 11, a main touch panel 12, and a sub touch panel 13. Further, a receipt discharge port 10a is formed in a housing of the main unit 10.

A coin depositing port 20a, a coin discharge port 20b, a coin tray 20c and a bill depositing and discharge port 20d are formed in a housing of a cash receiving unit 20.

Furthermore, details of elements arranged in the main unit 10 and the cash receiving unit 20 are described later.

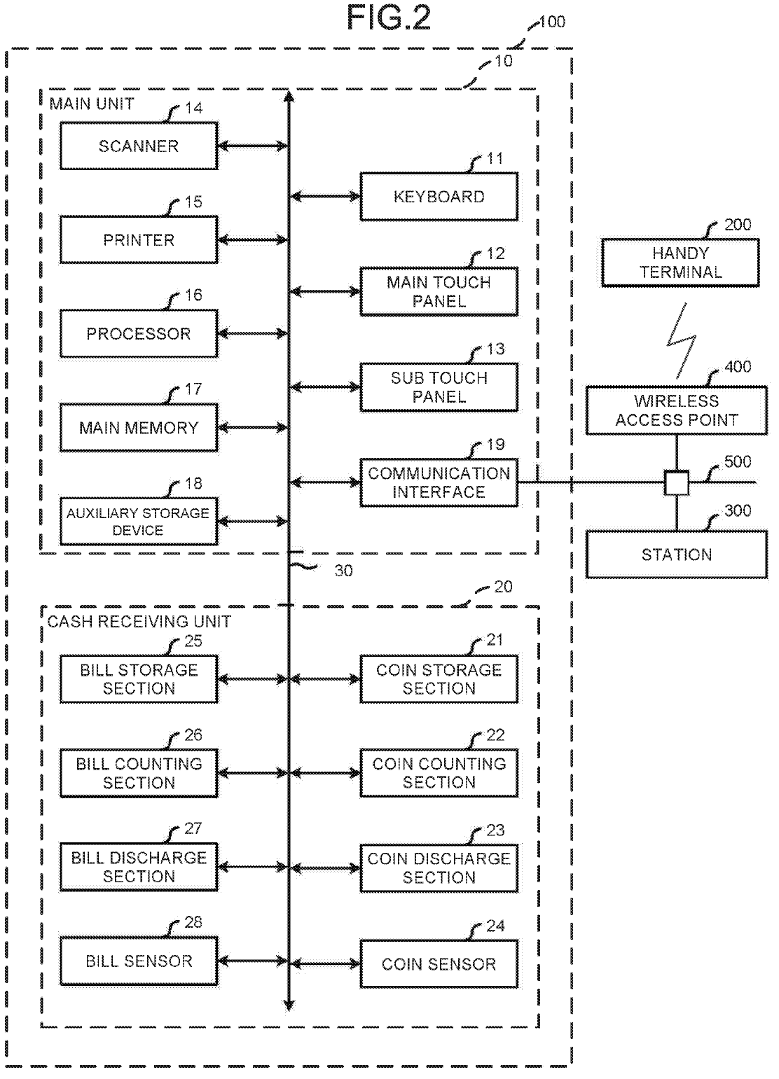

FIG. 2 is a block diagram illustrating a circuit arrangement of main portions of the checkout apparatus 100. Furthermore, in FIG. 2, elements also shown in FIG. 1 are applied with the same reference numerals as FIG. 1.

As shown in FIG. 2, the checkout apparatus 100 is part of a store system in the restaurant described above, along with a handy terminal 200 and a station 300.

The handy terminal 200 is a terminal device for inputting an operation by the store clerk for an order input. The handy terminal 200 wirelessly sends an item number of an ordered commodity according to the input operation. The item number wirelessly sent from the handy terminal 200 is transmitted to the station 300 via a wireless access point 400 and a communication network 500 such as an LAN (Local Area Network).

The station 300 is installed in, for example, a back office of the restaurant, generates order reception data of each group of customers on the basis of item numbers sent from the handy terminal 200, and manages the order reception data.

The main unit 10 includes a scanner 14, a printer 15, a processor 16, a main memory 17, an auxiliary storage device 18 and a communication interface 19, in addition to the keyboard 11, the main touch panel 12 and the sub touch panel 13. Each of the keyboard 11, the main touch panel 12, the sub touch panel 13, the scanner 14, the printer 15, the processor 16, the main memory 17, the auxiliary storage device 18 and the communication interface 19 is connected to a transmission path 30. The transmission path 30 includes an address bus, a data bus, and a control signal line. The transmission path 30 passes through from the main unit 10 to the cash receiving unit 20. Furthermore, the transmission path 30 may be divided into two parts by the main unit 10 side and the cash receiving unit 20 side, and further include an interface circuit for connecting these parts with each other.

The keyboard 11 includes a plurality of keys, and receives instructions by the store clerk.

The main touch panel 12 is arranged to face the store clerk side as shown in FIG. 1. The main touch panel 12 displays a screen for indicating information thereon for the store clerk. Further, the main touch panel 12 inputs an instruction of the store clerk by the touch to the screen being displayed.

The sub touch panel 13 is arranged to face the customer side as shown in FIG. 1. The sub touch panel 13 displays a screen for indicating information thereon for the customer. Further, the sub touch panel 13 receives instructions by the customer.

The scanner 14 reads a symbol code such as a barcode or a two-dimensional code. The scanner 14 notifies the processor 16 of code data indicated in the read symbol code.

The printer 15 prints a receipt information on a receipt paper. The printer 15 discharges the receipt paper on which the receipt information or a voucher information is printed from the receipt discharge port 10a shown in FIG. 1 to outside of the main unit 10.

The processor 16, the main memory 17 and the auxiliary storage device 18 are connected by the transmission path 30 and make up a computer for controlling the checkout apparatus 100.

The processor 16 acts as a central part of the computer. The processor 16 controls each section of the checkout apparatus 100 to perform various functions of the checkout apparatus 100 on the basis of an operating system and an application program stored in the main memory 17 and executed by the processor 16.

The main memory 17 acts as a main storage part of the computer. The main memory 17 includes a nonvolatile memory area and a volatile memory area. The main memory 17 stores the operating system and the application program in the nonvolatile memory area. Further, there is a case in which the main memory 17 stores data required for executing various information processing by the processor 16 in the nonvolatile or volatile memory area. The main memory 17 uses the volatile memory area as a working area in which the data is properly rewritten by the processor 16.

The auxiliary storage device 18 is, for example, an EEPROM (Electric Erasable Programmable Read-Only Memory), an HDD (Hard Disc Drive), or an SSD (Solid State Drive). The auxiliary storage device 18 stores data used by the processor 16 which carries out various information processing, and data generated in the processing by the processor 16. There is a case in which the auxiliary storage device 18 stores the application program described above.

The communication interface 19 is an interface of data communication via the communication network 500.

The cash receiving unit 20 includes a coin storage section 21, a coin counting section 22, a coin discharge section 23, a coin sensor 24, a bill storage section 25, a bill counting section 26, a bill discharge section 27 and a bill sensor 28. Each of the coin storage section 21, the coin counting section 22, the coin discharge section 23, the coin sensor 24, the bill storage section 25, the bill counting section 26, the bill discharge section 27 and the bill sensor 28 is connected with the transmission path 30.

The coin storage section 21 stores coins deposited from the coin depositing port 20a shown in FIG. 1 in a coin storage house arranged in the cash receiving unit 20.

The coin counting section 22 counts an amount of the coins stored in the coin storage house by the coin storage section 21.

The coin discharge section 23 discharges the coins from the coin storage house to outside of the cash receiving unit 20 via the coin discharge port 20b shown in FIG. 1. The coins discharged from the coin discharge port 20b are received by the coin tray 20c shown in FIG. 1.

The coin sensor 24 detects the coins existing on the coin tray 20c.

The bill storage section 25 stores bills deposited from the bill depositing and discharge port 20d shown in FIG. 1 in a bill storage house arranged in the cash receiving unit 20.

The bill counting section 26 counts an amount of the bills stored in the bill storage house by the bill storage section 25.

The bill discharge section 27 discharges the bills from the bill storage house to outside of the cash receiving unit 20 via the bill depositing and discharge port 20d shown in FIG. 1. A part of the bills discharged by the bill discharge section 27 is held by the bill depositing and discharge port 20d in a state in which the part protrudes from the bill depositing and discharge port 20d to the outside of the cash receiving unit 20.

The bill sensor 28 detects the bills in a state in which the bills are discharged by the bill discharge section 27 and held by the bill depositing and discharge port 20d in the protruded state as described above.

The operations of the checkout apparatus 100 are described next.

The checkout apparatus 100 carries out a processing for a settlement of a payment of each group on the basis of the order reception data managed by the station 300. Thus, the order reception data is described prior to the description of specific operations of the checkout apparatus 100.

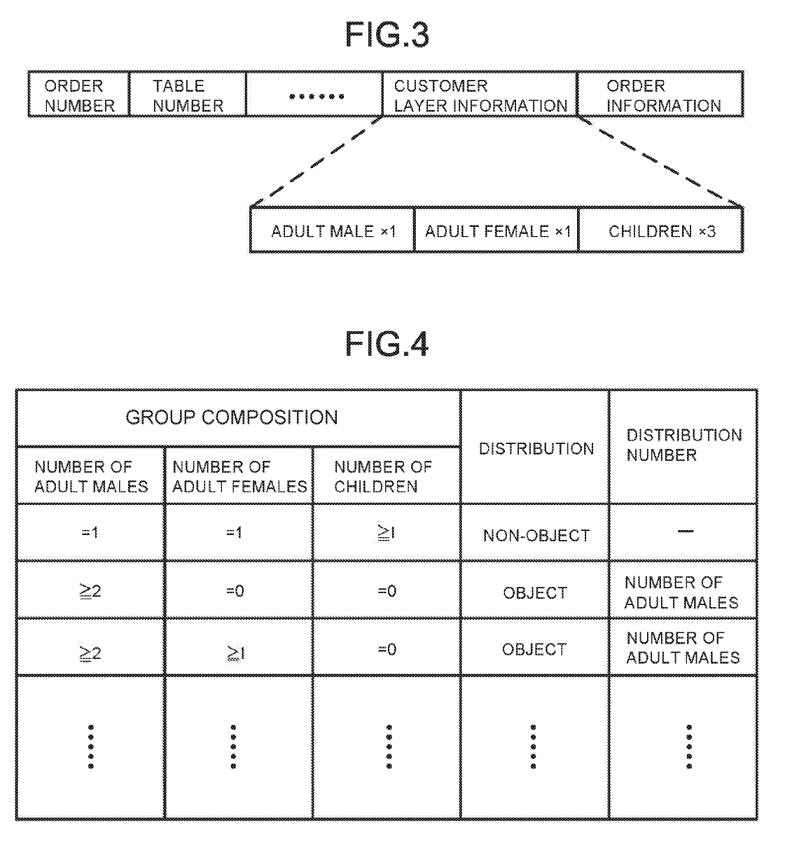

FIG. 3 is a diagram schematically illustrating an example of the order reception data.

As shown in FIG. 3, the order reception data includes management information such as an order number and a table number, and customer layer information and order information.

The order number is determined by the handy terminal 200 in order to individually identify respective treatments relating to a plurality of customer groups. Furthermore, the order number may be determined by the station 300. The table number is a number previously assigned to a table being used by a corresponding customer group, and is input to the handy terminal 200 by the store clerk. In addition, as the management information, for example, any information such as reception time may be included.

The customer layer information indicates customer layers of members that make up a customer group. The customer layers are an example of attributes of each customer classified on the basis of the viewpoint of the age and the sex. In the present embodiment, the customer layers are classified into “adult males”, “adult females” and “children”. The “adult males” and the “adult females” are examples of attributes classified and hierarchized on the basis of a combination of the age class and gender. The “children” is an example of classified and hierarchized attributes divided into two parts (adults, children) from the viewpoint of age class. Therefore, the customer layers may be classified and hierarchized into “males” and “females” on the basis of the viewpoint of gender, and “adults” are further subdivided on the basis of the viewpoint of age class, and may be classified and hierarchized into “youths”, “prime of life”, “middle age”, and “old age”. The customer layer information is input to the handy terminal 200 by the store clerk at the time of reception of an order. FIG. 3 illustrates an example of a case in which a customer group is a family composed of one adult male, one adult female and three children. Furthermore, there is also a case in which the customers who are adults do not match with their age class through the determination of the store clerk. This customer layer information is equivalent to attribute information representing attributes of members belonging to a group.

The order information includes a record of each of ordered commodities. The record includes information of, for example, an item number, a commodity name, a price and an amount. The item number is a predetermined number in order to identify each of the commodities. The commodity name is a name of the corresponding commodity. The price is a unit price of the corresponding commodity. The amount is an order number of the corresponding commodity.

Furthermore, if the order is completed, the station 300 enables the printer (not shown in FIG. 2) to print an order slip representing order contents. The station 300 enables the symbol code representing at least the order number to be printed collectively on the order slip. The order slip is transferred to the customer by the store clerk before the customer starts the settlement.

If the customer finishes food and drink of the ordered commodities and is leaving the restaurant, the customer goes to the checkout corner, and transfers the order slip described above to the store clerk. The store clerk enables the scanner 14 to read the symbol code printed on the order slip. If the scanner 14 reads the symbol code, the scanner 14 notifies the processor 16 of the order number indicated in the symbol code. At this time, the store clerk may input the order number printed on the order slip through the keyboard 11, and in this case, the order number is notified from the keyboard 11 to the processor 16.

If the order number is notified in this way, the processor 16 executes an information processing for the settlement according to the application program stored in the main memory 17 or the auxiliary storage device 18.

Furthermore, setting data relating to distribution of change is stored in advance in the main memory 17 or the auxiliary storage device 18 for the information processing described later by the processor 16. Furthermore, this setting data may be stored in a storage device included in the station 300, a storage device (not shown) connected with the communication network 500, or another storage device (not shown) communicable via another communication network such as the Internet.

FIG. 4 is a diagram schematically illustrating an example of the setting data.

As shown in FIG. 4, the setting data indicates an object (target) or non-object (non-target) of distribution of change, and distribution number in a case of distributing the change, in association with a combination of customer layers of members that make up a customer group.

In the example shown in FIG. 4, the setting data indicates that there is no object of the distribution of change for a customer group which includes one adult male and one adult female and children. Further, for a customer group including only two or more adult males, there are two objects of the distribution of change, and the distribution number indicates the number of the adult males belonging to the customer group.

The setting data is determined by, for example, a designer of the checkout apparatus 100, and is written into the main memory 17 or the auxiliary storage device 18 in the manufacture process. Or, the setting data may be determined by a user and written into the main memory 17 or the auxiliary storage device 18 under the operation by the user.

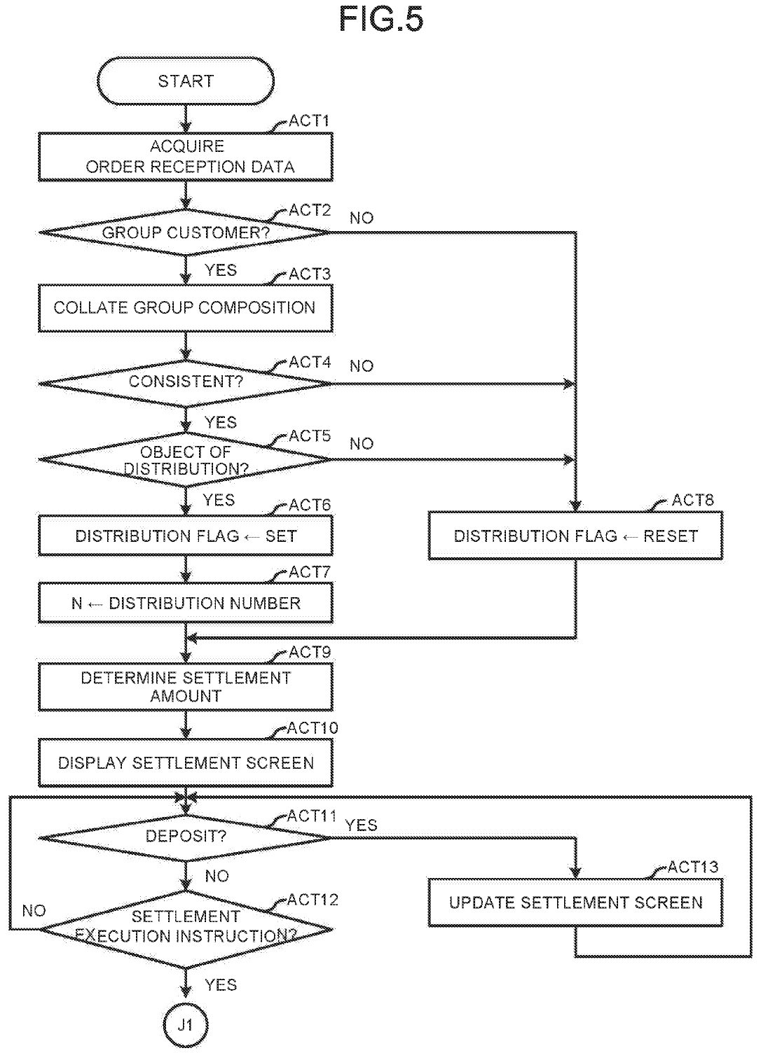

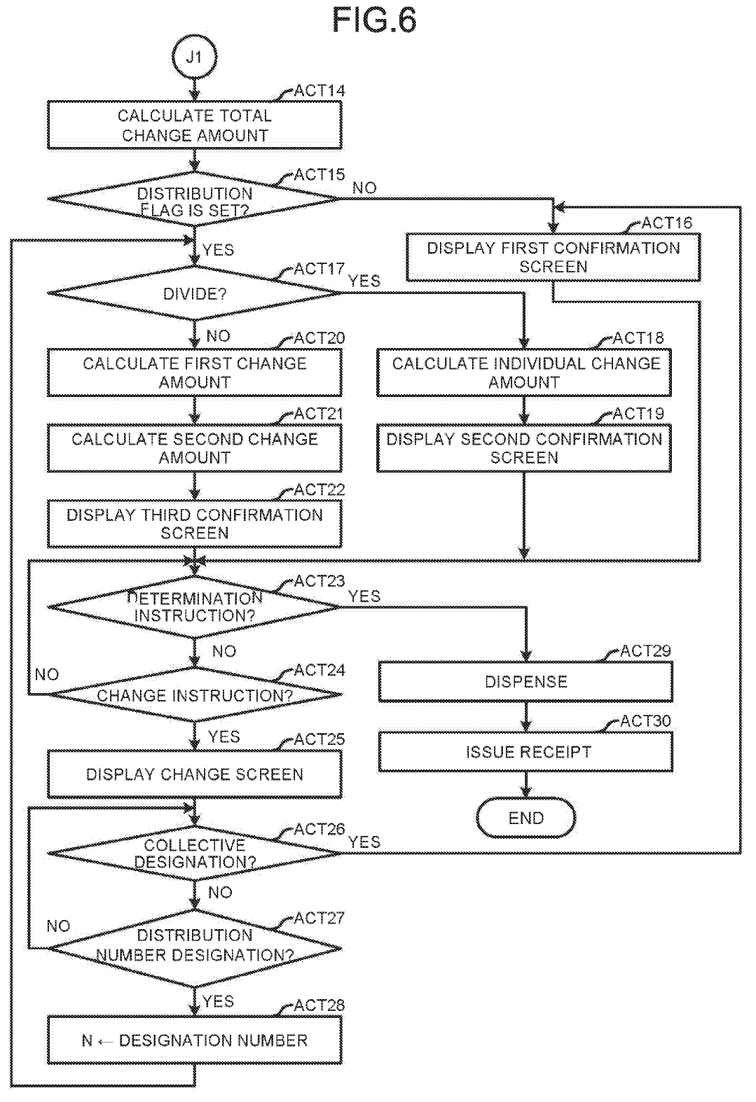

FIG. 5 and FIG. 6 are flowcharts depicting the information processing by the processor 16 for settlement. Furthermore, the contents of the processing described later are one example, and various processing capable of achieving the same result may be utilized. For example, sequences of some operations may be replaced. Further, some operations may also be omitted, or additional operations may also be added and executed.

In FIG. 5, the processor 16 acquires the order reception data including the order number notified as described above from the station 300 (Act 1). Furthermore, in the following, in a case in which “order reception data” is noted without particular explanation, the “order reception data” refers to the order reception data acquired herein. As described above, the order reception data includes the customer layer information as the attribute information. In other words, the acquisition of the order reception data means acquiring the customer layer information as the attribute information. In this way, the computer of which the central part is the processor 16 functions as an acquisition module which acquires the attribute information in such a manner that the processor 16 executes the information processing based on a program.

The processor 16 confirms whether or not it is a group customer on the basis of the customer layer information included in the order reception data (Act 2). Then, the processor 16 determines Yes if the customer layer information indicates customer layers relating to a plurality of customers, and proceeds to a processing in Act 3.

The processor 16 collates a combination of customers indicated in the customer layer information included in the order reception data with a group composition indicated in the setting data (Act 3).

The processor 16 confirms whether or not the group composition consistent with the combination of customers is indicated in the setting data through the collation (Act 4). Then, the processor 16 determines Yes if it is consistent, and proceeds to a processing in Act 5.

The processor 16 confirms whether or not the group composition consistent with the combination of customers is taken as the object of the distribution of change in the setting data (Act 5). Then, the processor 16 determines Yes if it is taken as the object, and proceeds to a processing in Act 6.

The processor 16 sets a distribution flag to a set state (Act 6). The distribution flag is data of one bit stored in the main memory 17 or the auxiliary storage device 18.

The processor 16 substitutes a variable N for the distribution number indicated in the setting data corresponding to the predetermined group composition consistent with the combination of customers (Act 7). Specifically, the processor 16 substitutes the variable N for the number of adult males indicated in the customer layer information included in the order reception data if, for example, the “number of adult males” is indicated as the distribution number as shown in FIG. 4. After that, the processor 16 proceeds to a processing in Act 9.

On the other hand, the processor 16 determines No in Act 2 if the customer layer information included in the order reception data indicates the customer layer relating to one customer, and proceeds to a processing in Act 8. The processor 16 determines No in Act 4 if the group composition consistent with the combination of customers is not indicated in the setting data, and proceeds to a processing in Act 8. The processor 16 determines No in Act 5 if the group composition consistent with the combination of customers is taken as the non-object of the distribution of change in the setting data, and proceeds to a processing in Act 8.

The processor 16 sets the distribution flag to a reset state (Act 8). Then, the processor 16 proceeds to a processing in Act 9 after that.

The processor 16 determines an amount to be paid (hereinafter, referred to as “payment amount”) on the basis of the order information included in the order reception data (Act 9). This processing may be, for example, the same as a processing which is carried out by the same existing kind of checkout apparatus.

The processor 16 causes the sub touch panel 13 to display a settlement screen (Act 10).The settlement screen informs the customer a payment amount to make the customer deposit cash for settling the payment.

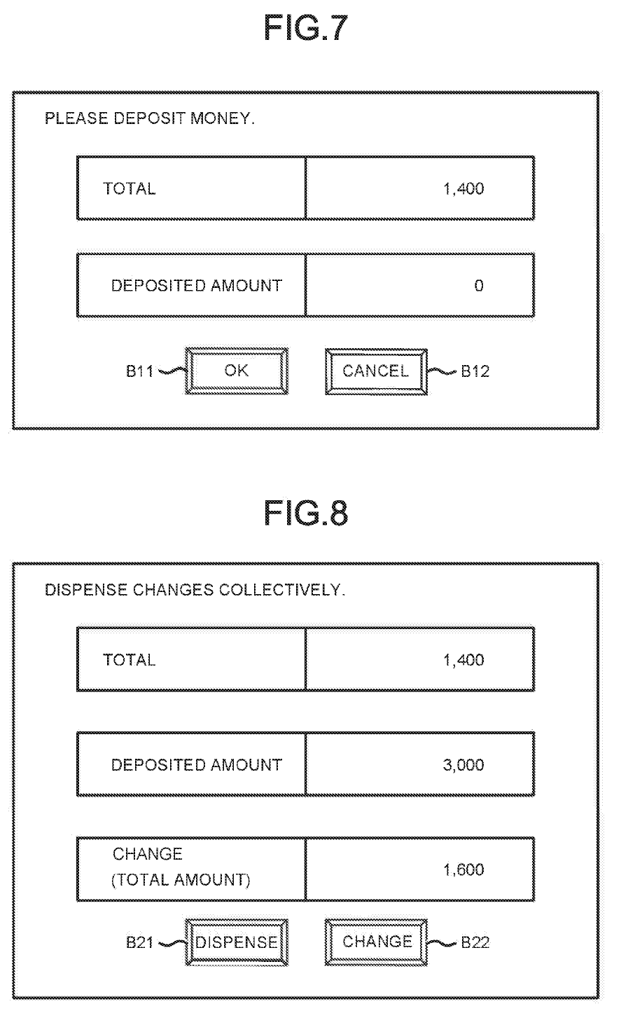

FIG. 7 is a diagram illustrating an example of the settlement screen;

FIG. 7 illustrates the settlement screen in an initial state in a case where the total payment amount is 1,400 yen. The settlement screen includes buttons B11 and B12. The button B11 receives an instruction by the customer to execute settlement. The button B12 receives an instruction by the customer to cancel the settlement.

In FIG. 5, the processor 16 confirms whether or not cash is deposited (Act 11). Then, the processor 16 determines No if cash is not deposited, and proceeds to a processing in Act 12.

The processor 16 confirms whether or not the settlement execution is instructed by a customer through the button B11 (Act 12). Then, the processor 16 determines No if the instruction is not made, and returns to the processing in Act 11.

In this way, the processor 16 waits for deposit of cash or settlement instruction (Act 11 and Act 12).

The customer deposits coins or bills into the coin depositing port 20a or the bill depositing and discharge port 20d according to the guidance of the settlement screen displayed on the sub touch panel 13. Thus, the coin storage section 21 or the bill storage section 25 stores the deposited coins or bills to the coin storage house or the bill storage house in the cash receiving unit 20. At this time, the coin counting section 22 or the bill counting section 26 updates a deposit amount of coins or bills. If updating the deposit amount, the coin counting section 22 or the bill counting section 26 notifies the processor 16 of the updated deposit amount. The processor 16 determines Yes in Act 11 if receiving this notification, and proceeds to a processing in Act 13.

The processor 16 updates the settlement screen so as to display a sum total of the newest amounts of coins and bills deposited by the customer (Act 13). In other words, the processor 16 changes the deposit amount indicated as “0” in FIG. 7 so as to display the sum total. Then, the processor 16 returns to the wait state in Act 11 and Act 12 after that.

The customer presses the button B11 on the settlement screen if the customer finishes depositing cash equal to the settlement amount or more. The sub touch panel 13 notifies the processor 16 of this message. Then, the processor 16 determines Yes in Act 12 if receiving this notification, and proceeds to a processing in Act 14 in FIG. 6. Furthermore, in a case in which the button B12 on the settlement screen is pressed, the processor 16 ends the execution of the information processing shown in FIG. 5 and FIG. 6 after carrying out a processing for cancelling.

The processor 16 calculates a total change amount by deducting the settlement amount from the deposit amount of the coins or bills (Act 14).

The processor 16 confirms whether or not the distribution flag is in the set state (Act 15). Then, the processor 16 determines No if the distribution flag is in not in the set state, and proceeds to a processing in Act 16.

In Act 16, the processor 16 causes the sub touch panel 13 to display a first confirmation screen. The first confirmation screen is a screen for enabling the customer to confirm that the total change amount is dispensed collectively.

FIG. 8 is a diagram illustrating an example of the first confirmation screen.

FIG. 8 illustrates the first confirmation screen in a case where the total settlement amount is 1,400 yen, and 3,000 yen is deposited, and 1,600 yen is calculated as the total change amount. The first confirmation screen includes buttons B21 and B22. The button B21 inputs an instruction of dispensing execution by the customer. The button B22 inputs an instruction of change of a dispensing form by the customer.

On the other hand, the processor 16 determines Yes in Act 15 in FIG. 6 if the distribution flag is in the set state, and proceeds to a processing in Act 17.

The processor 16 confirms whether or not the total change amount is divided by the variable N (Act 17). Then, the processor 16 determines Yes if the total change amount is divided, and proceeds to a processing in Act 18.

The processor 16 calculates an change amount for each person (hereinafter, referred to as “individual change amount”) in a case in which the total change amount is distributed to N people (Act 18). Specifically, the processor 16 sets an amount calculated by dividing the total change amount by N as the individual change amount.

The processor 16 causes the sub touch panel 13 to display a second confirmation screen (Act 19). The second confirmation screen is a screen for enabling the customer to confirm that change is equally divided among N people for dispensing.

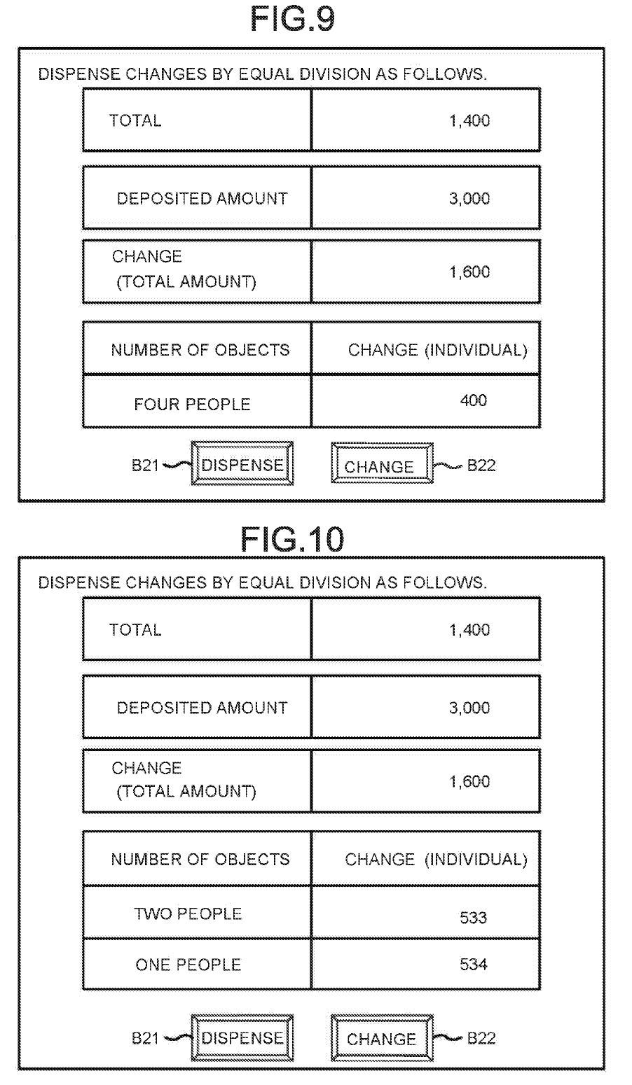

FIG. 9 is a diagram illustrating an example of the second confirmation screen.

FIG. 9 illustrates the second confirmation screen in a case where the total change amount is 1,600 yen, and the variable N is “4”. Thus, the second confirmation screen shown in FIG. 9 represents that change is equally divided to four people by 400 yen per capita for dispensing. The second confirmation screen also includes buttons B21 and B22.

Then, the processor 16 determines No in Act 17 in FIG. 6 if the total change amount cannot be divided by the variable N, and proceeds to a processing in Act 20.

The processor 16 calculates a first change amount (Act 20). Specifically, the processor 16 calculates the first change amount as a value obtained by rounding down decimal places of a value calculated by dividing the total change amount by the variable N. In other words, for example, if the total change amount is 1,600 yen, and the variable N is “3”, 533 yen is calculated as the first change amount.

The processor 16 calculates a second change amount (Act 21). Specifically, the processor 16 calculates the second change amount by deducting, from the total change amount, an amount calculated by multiplying a value obtained by subtracting 1 from the variable N by the first change amount. In other words, if the total change amount is 1,600 yen, the variable N is “3”, and 533 yen is calculated as the first change amount as described above, the second change amount is calculated as (1,600−533*(3−1)=534).

The processor 16 causes the sub touch panel 13 to display a third confirmation screen (Act 22). The third confirmation screen is a screen for enabling the customer to confirm that change is divided into the first change amount for N−1 people and the second change amount for one people for dispensing.

FIG. 10 is a diagram illustrating an example of the third confirmation screen.

FIG. 10 illustrates the third confirmation screen corresponds to the specific example described above in a case where 2*533 yen as the first change amount for two people and 534 yen as the second change amount for one people are dispensed. The third confirmation screen also includes buttons B21 and B22.

As described above, the processor 16 determines a distribution ratio of change on the basis of a combination of individual attributes of at least two people of members belonging to a group. In this way, the computer of which the central part is the processor 16 functions as a determination module for carrying out the determination in such a manner that the processor 16 executes the information processing based on a program.

If displaying the first, second or third confirmation screen in Act 16, Act 19 or Act 22 in FIG. 6, the processor 16 proceeds to a processing in Act 23 in any case.

The processor 16 confirms whether or not determination is instructed (Act 23). Then, the processor 16 determines No if the instruction is not made, and proceeds to a processing in Act 24.

The processor 16 confirms whether or not change is instructed (Act 24). Then, the processor 16 determines No if the instruction is not made, and returns to the processing in Act 23.

In this way, the processor 16 waits for that the determination or change is instructed in Act 23 and Act 24.

The customer presses the button B22 if the customer hopes to receive change in a different form from that displayed on the first, second or third confirmation screen. The sub touch panel 13 notifies the processor 16 of this request from the customer. Then, the processor 16 determines Yes in Act 24 if receiving this notification, and proceeds to a processing in Act 25.

The processor 16 causes the sub touch panel 13 to display a change screen (Act 25). The change screen is a screen for enabling the customer to carry out either collective designation indicating that change is dispensed collectively or designation to set a number for distributing the change to the designated number of the customers in the group to which the customers belong (hereinafter, referred to as “distribution number designation”) in a case of distributing change for several people. The customer carries out either the collective designation or the distribution number designation according to the change screen.

The processor 16 confirms whether or not the collective designation by the customer is carried out (Act 26). Then, the processor 16 determines No if the collective designation is not carried out, and proceeds to a processing in Act 27.

The processor 16 confirms whether or not the distribution number designation is carried out (Act 27). Then, the processor 16 determines No if the distribution number designation is not carried out, and returns to the processing in Act 26.

In this way, the processor 16 waits for that the collective designation or the distribution number designation is carried out in Act 26 and Act 27. Then, if the customer carries out the collective designation on the change screen, the sub touch panel 13 notifies the processor 16 of this request from the customer. Then, the processor 16 determines Yes in Act 26 if receiving this notification, and proceeds to the processing in Act 16. Then, the processor 16 executes the processing following ACT 16 as being similar to that described above. In other words, the processor 16 returns to the wait state in Act 23 and Act 24 in a state in which the first confirmation screen is displayed on the sub touch panel 13.

On the other hand, if the customer carries out the distribution number designation on the change screen, the sub touch panel 13 notifies the processor 16 of this request from the customer. Then, the processor 16 determines Yes in Act 27 if receiving this notification, and proceeds to a processing in Act 28.

The processor 16 substitutes the variable N for a value designated as the distribution number (Act 28). Then, the processor 16 executes the processing following ACT 17 as being similar to that described above after that. In other words, the processor 16 returns to the wait state in Act 23 and Act 24 in a state in which the second or third confirmation screen is displayed on the sub touch panel 13.

In a state in which the first, second or third confirmation screen is displayed on the sub touch panel 13, the customer presses the button B21 on the first, second or third confirmation screen in a case of confirming the dispensing of change in a form displayed on the confirmation screen being displayed. The sub touch panel 13 notifies the processor 16 of this request from the customer. Then, the processor 16 determines Yes in Act 23 if receiving this notification, and proceeds to a processing in Act 29.

The processor 16 carries out the dispensing of change as follows (Act 29).

(Case in which the Button B21 on the First Confirmation Screen is Pressed)

The processor 16 instructs the coin discharge section 23 and the bill discharge section 27 to dispense the total change amount by a combination of each denomination of which the dispensing number of cash is minimum.

For example, the processor 16 instructs the coin discharge section 23 to dispense coins of 500 yen and coins of 100 yen one by one, and instructs the bill discharge section 27 to dispense bills of 1,000 yen one by one in a case in which the button B21 is pressed on the first confirmation screen shown in FIG. 8.

(Case in which the Button B21 on the Second Confirmation Screen is Pressed)

The processor 16 instructs the coin discharge section 23 and the bill discharge section 27 to dispense the individual change amount by a combination of each denomination of which the dispensing number of cash is minimum. If the coin discharge section 23 and the bill discharge section 27 dispense cash depending on this instruction, at least one of the coin sensor 24 and the bill sensor 28 detects a detection target (i.e., coin or bill). Then, if the customer removes all of dispensed cash, both of the coin sensor 24 and the bill sensor 28 do not detect the detection target. Depending on this, the processor 16 instructs the coin discharge section 23 and the bill discharge section 27 to dispense the individual change amount in the same manner as described above. Then, the processor 16 repeats such dispensing of cash of the individual change amount N times separately.

For example, the processor 16 instructs the coin discharge section 23 to repeat the dispensing of four coins of 100 yen four times in a case in which the button B21 is pressed on the second confirmation screen shown in FIG. 9.

(Case in which the Button B21 on the Third Confirmation Screen is Pressed)

The processor 16 instructs the coin discharge section 23 and the bill discharge section 27 to dispense the first change amount by a combination of each denomination of which the dispensing number of cash is minimum. If the coin discharge section 23 and the bill discharge section 27 dispense cash depending on this instruction, at least one of the coin sensor 24 and the bill sensor 28 detects the detection target. Then, if the customer removes all of dispensed cash, both of the coin sensor 24 and the bill sensor 28 do not detect detection target. Depending on this, the processor 16 instructs the coin discharge section 23 and the bill discharge section 27 to dispense the first change amount in the same manner as described above. Then, the processor 16 repeats such dispensing of cash of the first change amount N−1 times. Furthermore, the processor 16 instructs the coin discharge section 23 and the bill discharge section 27 to dispense the second change amount by a combination of each denomination of which the dispensing number of cash is minimum if both of the coin sensor 24 and the bill sensor 28 detect detection target after the N−1^{th} dispensing.

For example, the processor 16 instructs the coin discharge section 23 to repeat the dispensing of one coin of 500 yen, three coins of 10 yen and three coins of 1 yen twice in a case in which the button B21 is pressed on the third confirmation screen shown in FIG. 10. Then, the processor 16 instructs the coin discharge section 23 to carry out the dispensing of one coin of 500 yen, three coins of 10 yen and four coins of 1 yen once after that.

As described above, the processor 16 controls the coin discharge section 23 and the bill discharge section 27 as dispensing mechanisms in order to dispense change by denomination distribution corresponding to distribution of change in the determined distribution pattern. In this way, the computer of which the central part is the processor 16 functions as a control module for carrying out the control in such a manner that the processor 16 executes the information processing based on a program.

In FIG. 6, the processor 16 instructs the printer 15 to issue a receipt indicating contents of an order serving as an object of a settlement and a result of the settlement (Act 30). Furthermore, the processor 16 indicates the items on a receipt in a case in which change is dispensed divisionally in a plurality of times. In this way, the computer of which the central part is the processor 16 achieves a function as a print module for printing a receipt as a voucher using the printer 15 in such a manner that the processor 16 carries out the information processing based on a program.

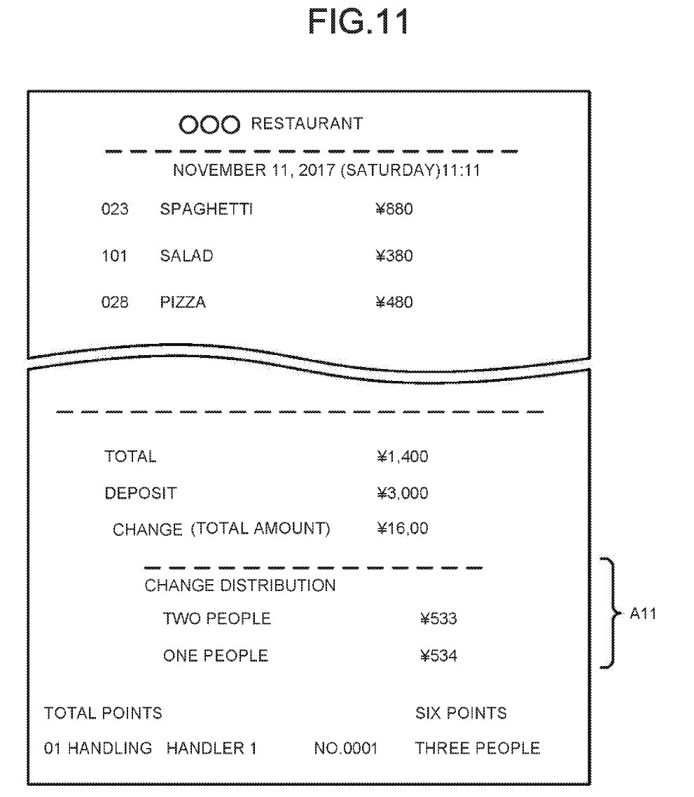

FIG. 11 is a diagram illustrating an example of a receipt.

The receipt shown in FIG. 11 is an example in which it is issued in a case in which the button B21 on the third confirmation screen shown in FIG. 10 is pressed. Then, change distribution is displayed in an area A11.

As described above, according to the checkout apparatus 100, for example, for the settlement amount of 1,600 yen, if three payers pay 3,000 yen with 1,000 yen per payer, 533 yen for each of two people and 534 yen for one people are dispensed as change respectively. Thus, at the time of such splitting the cost, split payment is simply carried out without the need of carrying out transmission and reception of cash among payers for adjustment of a payment amount. Then, according to the checkout apparatus 100, at the time of a settlement relating to a customer group in which there are, for example, three adult males, a dispensing form of change in the above form is proposed for the customer initially. Thus, the customer does not need to carry out complicated operations for dispensing change in the above form.

Further, according to the checkout apparatus 100, in the dispensing form as described above, change is dispensed divisionally in a plurality of times. Moreover, according to the checkout apparatus 100, the next dispensing is carried out after waiting for removal of the dispensed cash. Thus, the customer does not need to almost carryout an operation relating to the distribution of change as long as each payer receives change dispensed sequentially in this way.

Further, according to the checkout apparatus 100, in a case in which change is dispensed in the dispensing form as described above, a receipt indicating items is issued. Thus, even if the customer mixes change dispensed divisionally in a plurality of times by mistake, the customer can easily carry out subsequent redistribution according to the display of the receipt.

Further, according to the checkout apparatus 100, the dispensing form of change is changed depending on an instruction of the customer. Thus, in a case in which the dispensing form selected by the checkout apparatus 100 does not match the intention of the customer, the customer can designate the dispensing in a desired dispensing form.

The following various modifications of this embodiment can be applied.

In a case in which items only for children like a lunch for children are included in ordered items, it is understood that children are included in a customer group. Further, in a case in which items only for females or only for old people are included in ordered items, it is understood that females and/or old people are included in a customer group. Thus, the distribution pattern of change may be determined by considering that such specific items become ordered items as one of attributes of customers.

Ina case in which children are included in a customer group, since the children are excluded from the number of people who may perform payment, it is considered to select a distribution pattern of change by considering this. In a customer group having males and females, since payment burden of females is reduced with respect to males, it is considered to select a distribution pattern of change by considering this. In a case in which old people are included in a customer group, if childhood grandchildren are included in the group customer, since it is estimated that old people bear the payment a little more than their daughter and son-in-law or their son and daughter-in-law, it is considered to select a distribution pattern of change by considering this. Even if old people are included in a customer group, in a case in which adult grandchildren are included in the group customer, or in a case in which the group customer includes the elderly and their daughter and son-in-law or their son and daughter-in-law, since it is estimated that there is no payment burden of old people, it is considered to select a distribution pattern of change by considering this

In this way, a distribution pattern of change may be determined by considering not only attributes of respective customers that make up each customer group but also attributes of each customer group classified and hierarchized. As an example of attributes of each customer group, there are couple customers (married couples, girlfriends and boyfriends), family customers (based on a family composition such as a couple with infants, a three-generations family), student group customers (only males, only females, both males and females), work colleagues (only male colleagues, only female colleagues, both male colleagues and female colleagues, seniors and juniors, bosses and subordinates), friend group customers (mothers who are friends, classmates), neighbor group customers, relatives, parent association at a school, girls day/night out.

Such attributes of a customer group can be specified on the basis of information at the time of reservation reception, for example. Or, attributes of a customer group can be estimated (determined) and specified by a store clerk on the basis of an atmosphere of an occasion at the time of order reception and delivery of commodities articles, and contents of a conversation at the time of eating and drinking. Further, attributes of the customer group or a combination (pattern) of attributes of customers constituting the customer group may be specified on the basis of categories of ordered items relating to the customer group, the number of orders by items and a combination of ordered items.

It is possible that the processor 16 optionally changes a roundness unit for calculating the first change amount. For example, it is considered to determine the roundness width as 10, 50 or 100. Specifically, the processor 16 may calculate the first change amount such that the first change amount is a multiple of 50. In other words, for example, if the total change amount is 1,600 yen and the variable N is “3”, 500 yen is calculated as the first change amount. By the way, in this case, the processor 16 calculates 600 yen as the second change amount. Furthermore, the roundness width may be fixedly determined as a design value, or may be optionally changed by a user.

Dispensing of change in a form selected by the processor 16 may be executed without carrying out the processing in Act 24 to Act 28 in FIG. 6. Further, in this case, the processing in Act 23 may be omitted.

As described in the above embodiment, if the next dispensing is carried out after waiting for removal of change dispensed once, items may not be displayed on a receipt.

As described in the above embodiment, if a receipt indicating items of distribution of change is issued, change dispensed divisionally in a plurality of times in the above embodiment maybe collectively dispensed without any change to the number of each denomination.

An implementation as a settlement apparatus that carries out settlement of a settlement amount determined by an account processing in another apparatus is possible. In other words, the implementation as the settlement apparatus of a separate type semi-self-service checkout system that carries out the account processing and the settlement processing by different apparatuses is possible. Further, even in a case of implementing as a checkout device also having the function of the account processing, an implementation as a self-service system or a face-to-face system is possible. However, in a case of implementing as a checkout device of a face-to-face system, the operation carried out by a customer in the above embodiment is carried out by a store clerk, and a variety of display is carried out by a touch panel for store clerk. Dispensed change is also taken out by a store clerk, and handed over from the store clerk to the customer.

The same operator may provide hardware of the checkout apparatus 100 and an application program serving as procedures of an information processing executed on the hardware, and different operators may provide the hardware and the application program to individuals respectively. In a case in which the same operator provides the hardware and the application program of the checkout apparatus 100 to a user of the checkout apparatus 100, the application program is generally provide din a state of being stored in the main memory 17 or the auxiliary storage device 18 serving as thee hardware of the checkout apparatus 100. However, even in a case of such a provision, it is not necessary that the application program is in a state of being stored in the main memory 17 or the auxiliary storage device 18 serving as the hardware of the checkout apparatus 100. For example, the application program may be provided in a state of being recorded in a removable recording medium such as a magnetic disk, a magneto-optical disk, an optical disk, and a semiconductor memory which is not the hardware of the checkout apparatus 100, or may be provided by downloading from a network resource.

Part or all of functions implemented by the processor 16 through the information processing can also be implemented through hardware such as a logic circuit for executing the information processing not based on a program. Further, each of the above functions can also be implemented by combining software control with the hardware such as the logic circuit.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A checkout machine, comprising:
a bill discharge section;
a coin discharge section;
a communication interface; and
a processor configured to acquire attribute information of a group through the communication interface, determine a distribution pattern of change on the basis of the attribute information, and control the bill discharge section and the coin discharge section to dispense change according to the determined distribution pattern.

2. The checkout machine according to claim 1, wherein
the processor is configured to control the bill discharge section and the coin discharge section to sequentially dispense change according to the distribution pattern determined by the processor.

3. The checkout machine according to claim 2, wherein
the processor determines, depending on an operation by an operator, a distribution pattern that is based on the attribute information or some other distribution pattern.

4. The checkout machine according to claim 2, wherein
the processor determines the distribution pattern depending on an operation by members belonging to the group.

5. The checkout machine according to claim 1, further comprising:
a printer configured to print a voucher indicating an amount of change that is dispensed according to the distribution pattern determined by the processor.

6. A method for controlling a checkout machine having a bill discharge section, a coin discharge section, and a communication interface, the method including:
acquiring a plurality of attribute information representing attributes of a group through the communication interface;
determining a distribution pattern of change on the basis of the attribute information acquired; and
controlling the bill discharge section and the coin discharge section to dispense change according to the determined distribution pattern.

7. The method according to claim 6, wherein
controlling the bill discharge section and the coin discharge section to sequentially dispense change according to the determined distribution pattern.

8. The method according to claim 7, wherein
determining, depending on an operation by an operator, a distribution pattern that is based on the attribute information or some other distribution pattern.

9. The method according to claim 7, wherein
the distribution pattern is determined depending on an operation by members belonging to the group.

10. The method according to claim 6, further comprising:
printing a voucher indicating an amount of change that is dispensed according to the determined distribution pattern.
